(19) United States
(12) Patent Application Publication
(10) Pub. No.: US 2010/0150316 A1
(43) Pub. Date: Jun. 17, 2010

(54) X-RAY APPARATUS AND DETECTION UNIT FOR AN X-RAY APPARATUS

(75) Inventor: Michael Thoms, Baden-Wurtemberg (DE)

Correspondence Address: LEMPIA BRAIDWOOD LLC, One North LaSalle Street, CHICAGO, IL, 60602, US

(73) Assignee: DOR DENTAL AG, Bietgheim-Bissingen (DE)

(21) Appl. No.: 12/596,247

(22) PCT Filed: Mar. 7, 2008
(86) PCT No.: PCT/EP08/01815

§ 371 Date: Feb. 19, 2010

(30) Foreign Application Priority Data
Apr. 30, 2007 (DE) 102007020642.0

(51) Int. Cl. G01N 23/04

(52) U.S. Cl. 378/189

(57) ABSTRACT

The invention relates to an x-ray apparatus (10) with an x-ray radiation source (12) and a detector unit (14) in which the detector unit (14) comprises a plurality of detectors (74) which merely absorb a part of the x-rays that are hitting them and which are arranged next to each other with parallel spaces therebetween. It is possible by means of the x-ray apparatus and/or the detector unit to obtain a plurality of sectional views of an object penetrated by radiation with a single photograph, which views correspond to focus planes with spaces therebetween.

The invention relates to an X-ray apparatus with
a) a source of X-radiation for transirradiating an object, said source being capable of being displaced along a displacement path by means of a first drive means; and
b) a detection unit on which X-radiation impinges after penetrating the object and which is capable of being moved along a detection displacement path by means of a second drive means.

In addition, the invention relates to a detection unit for an X-ray apparatus, with at least one at least two-dimensionally resolving detector with a radiosensitive surface.

In X-ray apparatuses of the aforementioned type the detection unit ordinarily includes an integrating, two-dimensionally resolving detector with a planar radiosensitive surface, in which connection it may be a question, for example, of a digitally readable storage foil, a CCD sensor or a CMOS sensor.

During the X-ray exposure the source of X-radiation and the detection unit are moved simultaneously about a common centre of rotation, whereby the ratio of the spacing of the centre of rotation from the detector to the spacing of the centre of rotation from the source of X-radiation remains the same.

In the course of rotation, the source of X-radiation and the detection unit move in opposite directions on parallel rectilinear paths, the centre of rotation being displaced on a path parallel to the paths of the source of X-radiation and the detection unit.

The detector is arranged in such a way that its planar surface facing towards the source of radiation extends parallel to the path of the detection unit, and the source of X-radiation is rotated in accordance with the position of the detection unit in such a way that the X-radiation impinges on the detection unit or, to be more exact, the detector after penetrating the object to be transirradiated.

In the case of the object it is a question, in the case of a medical application of the X-ray apparatus, of a body part of a patient, especially—in the case of a dental application of the X-ray apparatus—the mandibular arch or dental arch of a patient.

During the displacing of the source of X-radiation and of the detection unit along their paths a plurality of single exposures are produced, which are combined to yield an overall image.

To each single exposure a narrow, planar projection region has to be assigned, within which the tissue of a patient penetrated by the X-radiation is sharply imaged. Expressed simply, in each instance narrow vertical regions of single images are accordingly combined.

By virtue of the simultaneous movement of the detection unit and the source of X-radiation in a movement plane, a sharp image is obtained in only one plane, the so-called focal plane, which is situated parallel to the movement plane of the detection unit and the source of X-radiation is and contains the centre of rotation. Planes parallel to this focal plane are imaged in blurred or fuzzy manner with increasing spacing from the focal plane and with increased stewing angle.

The standard method elucidated above has the disadvantage that the X-ray density of the object can be captured precisely only in one focal plane, this frequently being insufficient for an adequate diagnosis.

In order to counteract this, computerized tomography was developed, in the course of which the source of X-radiation and the detection unit are rotated about the object by 180° and an X-ray image is captured for each angular step of the rotation. From the plurality of the two-dimensional X-ray images recorded in this way, the three-dimensional data of the X-ray density can be ascertained via a computing-intensive method.

The disadvantage of computerized tomography consists in the fact that the X-ray dose to which a patient is subjected during the exposure is very high by reason of the plurality of X-ray images recorded. In addition, an intensive computational effort is necessary in order to obtain the desired three-dimensional images.

Furthermore, frequently very much more volume data is captured than is necessary for the respective special diagnosis, this being likewise associated with an unnecessarily high X-ray dose.

The object of the invention is to make available an X-ray apparatus as well as a detection unit for an X-ray apparatus, by means of which several high-resolution sectional images can be generated with a relatively low X-ray dose, whereby the computational effort remains slight.

With reference to the aforementioned X-ray apparatus, this object is achieved in that
c) the detection unit includes at least two detectors which
   ca) react to X-ray light; and
   cb) are arranged one behind the other in parallel-spaced manner;
      whereby
d) the detectors each absorb only a fraction of the X-radiation impinging on them.

Concerning the aforementioned detection unit, the object is achieved in that
a) at least two detectors are provided which are arranged in such a manner that the surfaces of the detectors extend parallel to one another; and
b) the detectors only partly absorb X-radiation.

In other words, the radiosensitive surfaces of the detectors are arranged one behind the other in the radiation direction. The position of the focal plane in which a sharp image is obtained depends—given predetermined exposure parameters which include, inter alia, the tube voltage, the exposure-time, the beam current and the beam cross-section—on the spacing of the detector from the source of radiation.

Since in the case of at least two detectors which are spaced in the beam direction also two different spacings of a detector from the source of X-radiation result, to each detector a focal plane has to be respectively assigned which is spaced from the focal plane of another detector.

In this way, several tomograms corresponding to the number of detectors can be produced with a single exposure.

Advantageous configurations of the invention are specified in dependent claims.

Exemplary embodiments of the invention will be elucidated in more detail on the basis of the appended drawing. Shown in the latter are:

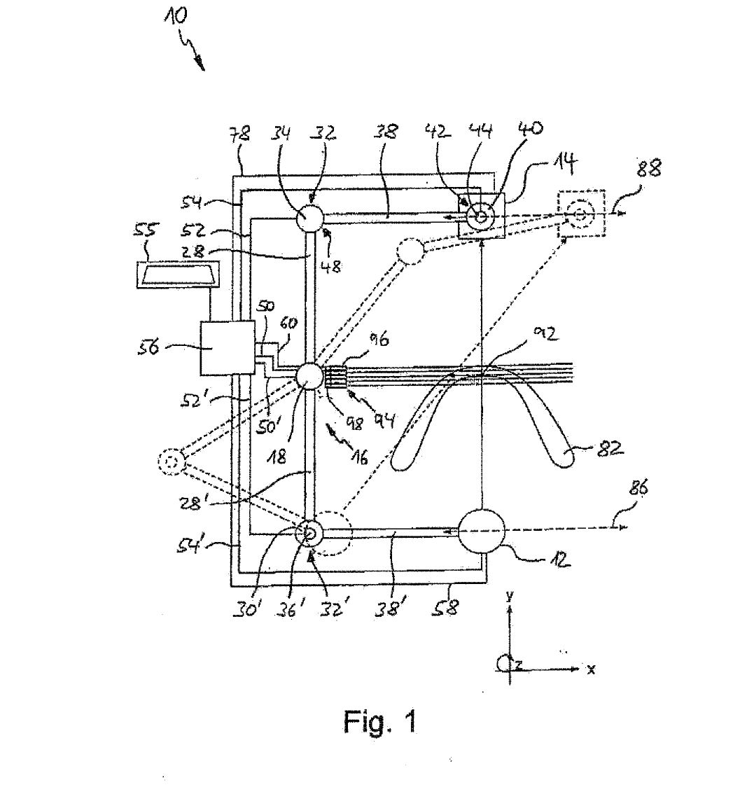

FIG. 1 a top view of an X-ray apparatus represented schematically;

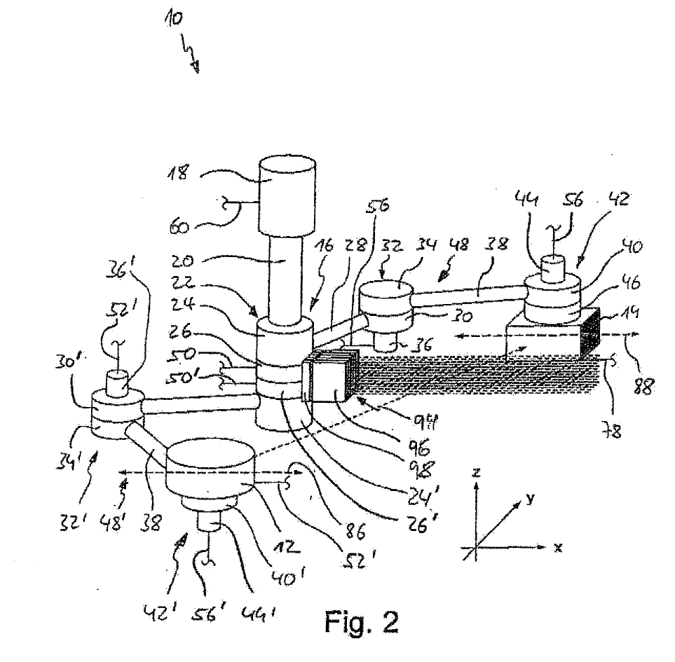

FIG. 2 a perspective view of the X-ray apparatus according to FIG. 1;

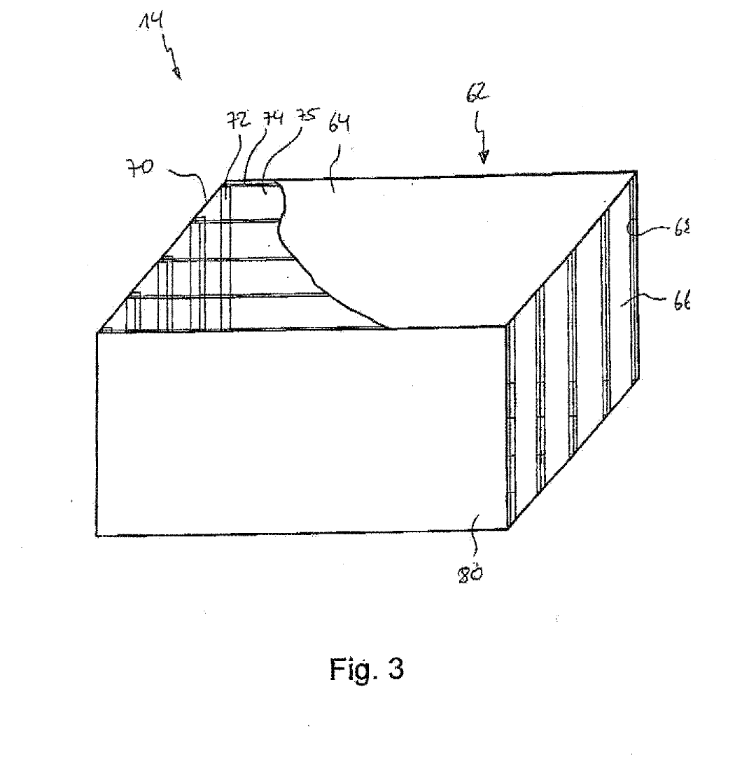

FIG. 3 a first exemplary embodiment of a sensor unit;

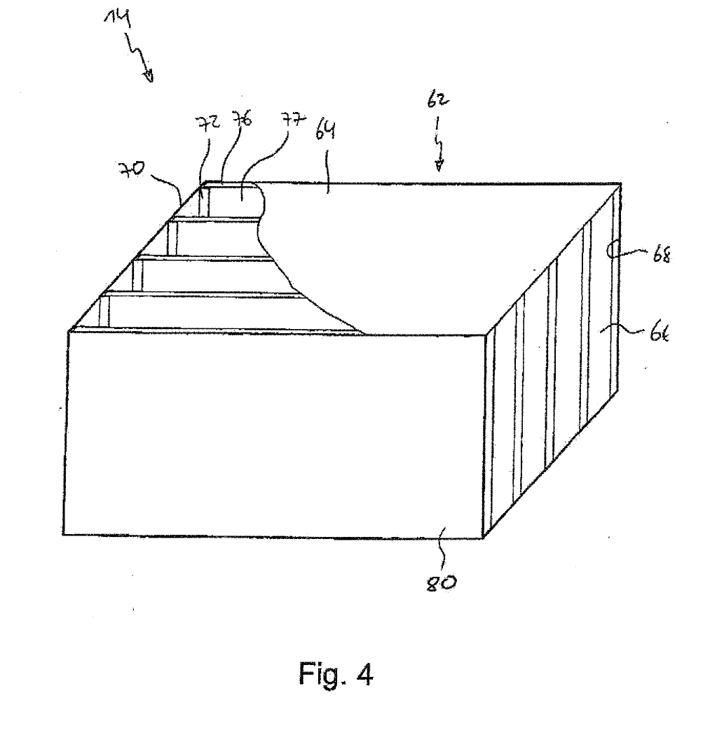

FIG. 4 a second exemplary embodiment of a sensor unit;

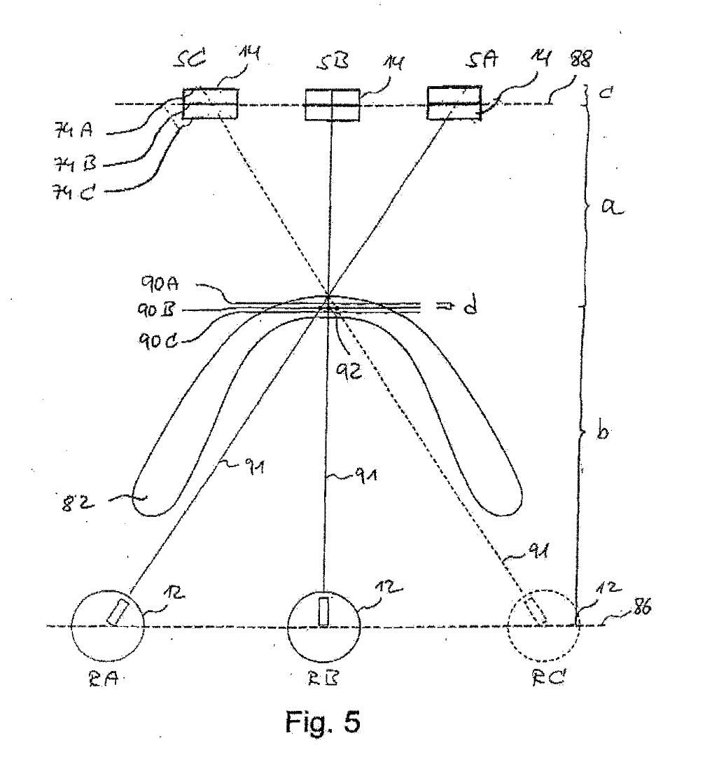

FIG. 5 a scheme for illustrating a possible operating principle of the X-ray apparatus according to FIGS. 1 and 2, wherein a detection unit with three detectors is shown;

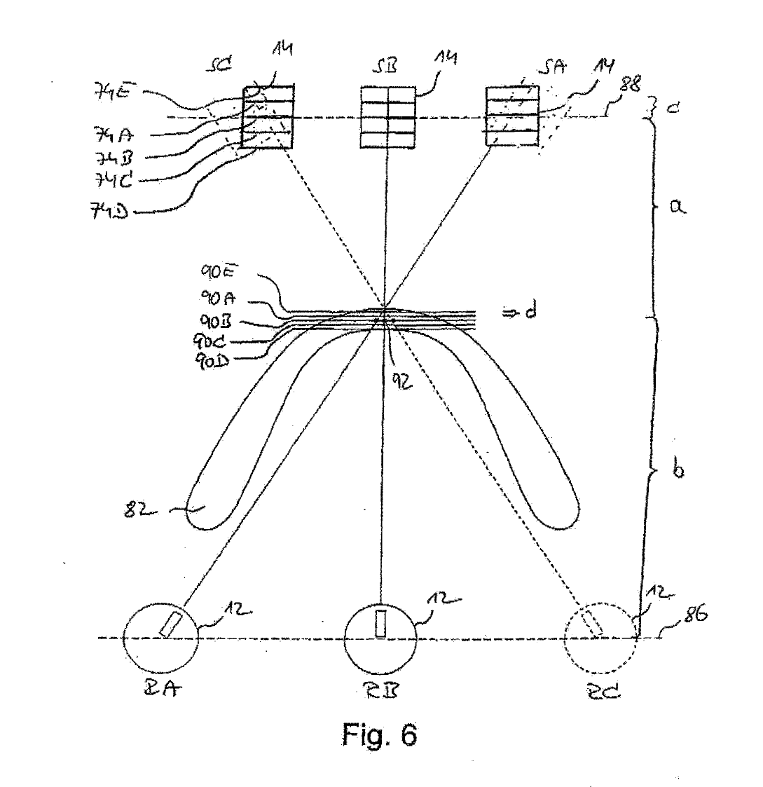

FIG. 6 a representation corresponding to FIG. 5, wherein a detection unit with five detectors is shown;

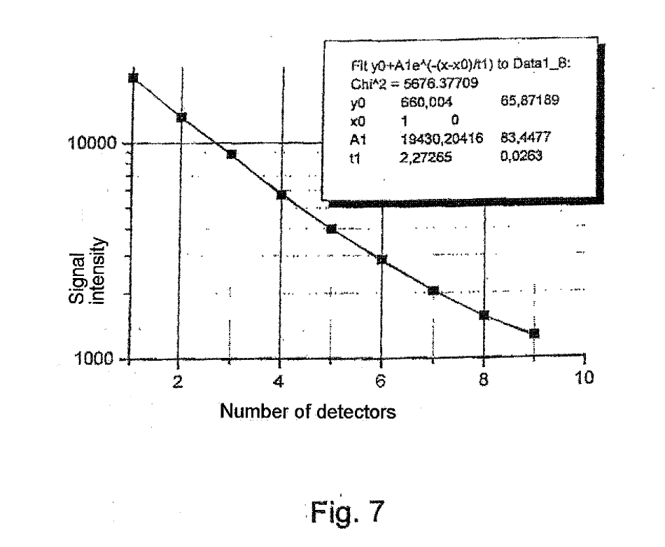

FIG. 7 a diagram in which the decrease in intensity of the X-radiation is shown qualitatively, depending on how many detectors the X-radiation has already penetrated; and

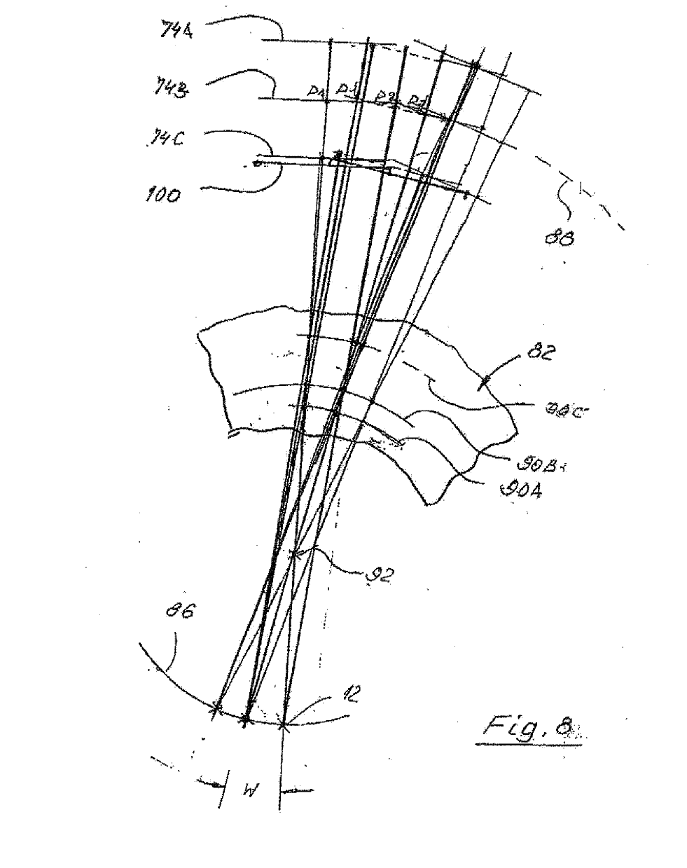

FIG. 8 a schematic representation of the imaging conditions in the case of imaging of a circular-arc-shaped portion of a jaw.

In FIGS. 1 and 2 an X-ray apparatus is denoted overall by 10.

The X-ray apparatus 10 includes a source of X-radiation 12 and a detection unit 14, which are borne by a movable articulated bar linkage 16. The latter is capable of being displaced in the z-direction by means of a hydraulic cylinder 18 with a piston rod 20, the hydraulic cylinder 18 being fastened to a building wall, which is not shown here, or to an appropriate frame.

In the case of the xyz coordinate system indicated in FIGS. 1 and 2 the z-axis coincides with the axis of the piston rod 20; the x-axis and the y-axis are each fixed in space.

The piston rod 20 bears at its free end a double joint 22. A first joint part 24 of the double joint 22 is capable of being rotated about the z-axis by an electric motor 26 and is rigidly connected via an inner supporting rod 28 to a first joint part 30 of an arm joint 32.

A second joint part 34 of the arm joint 32 is capable of being rotated about the z-axis via an electric motor 36 and is rigidly connected via an outer supporting rod 38 to a first joint part 40 of an end joint 42.

A second joint part 46 of the end joint 42, which is capable of being rotated about the z-axis via an electric motor 44, bears the detection unit 14.

Components 24 to 46 elucidated above form a first principal arm 48 of the articulated bar linkage 16. A second principal arm 48′ exhibits the same components as principal arm 48; these are labelled in FIGS. 1 and 2 with corresponding reference symbols plus a dash.

The second joint part 46′ of the end joint 42′ bears the source of X-radiation 12.

The source of X-radiation 12 and the detection unit 14 are located substantially at the same height in a common xy-plane, for which purpose in the case of components 24′ to 46′ of principal arm 48′ have been reversed in relation to the corresponding components of principal arm 48, with the same vertical dimensions at the top and at the bottom.

As can be discerned in FIG. 1, the electric motors 26, 36, 44 and also 26′, 36′, 44′ are connected to a control/computing unit 56 via lines 50, 52, 54 and 50′, 52′, 54′, respectively.

The source of X-radiation 12 communicates via a line 58 with the control/computing unit 56, so that, via the latter, exposure parameters—such as, for example, the tube voltage, the exposure-time, the beam current and the beam cross-section for the source of X-radiation 12—can be adjusted.

The corresponding parameters can be entered into the control/computing unit 56 by means of a keyboard 55.

The control/computing unit 56 is furthermore connected via a line 60 to a control valve which is not shown here and via which a pressure-means pump can be connected to the hydraulic cylinder 18, as a result of which the position of the cylinder rod 20 is adjustable and the position of the articulated bar linkage 16 on the z-axis can be adjusted.

The X-ray apparatus 10 includes, in addition, a luminous unit 94, which will be elucidated more precisely further below.

In FIG. 3 an exemplary embodiment of the sensor unit 14 is shown. The latter includes a housing 62 consisting of material that is opaque to visible light and transparent to X-radiation. An upper top wall 64 is shown partly broken away.

A side wall 66 standing perpendicular to the top wall 64 exhibits five slots 68 protected against incidence of is light, which are evenly spaced from one another and extend perpendicular to the top wall 64. In the interior of the housing there are provided guide grooves 72 on side wall 70, which is parallel to side wall 66, on the top wall 64 and on the side wall parallel thereto, which is not visible in FIG. 3, in which connection further guide grooves disposed on the inside of the top wall 64 have not been represented, for the sake of clarity.

In the guide grooves 72 there are seated digitally readable detector foils 74 which have been inserted into the guide grooves 72 of the housing 62 through the slots 68.

The detector foils 74 exhibit a planar surface 75 facing towards the source of radiation and have been produced from such a material that they do not completely absorb X-radiation impinging on them, but only partly, this being elucidated in more detail below.

This property is exhibited by, for example, both classical silver-halide X-ray films and storage foils and combinations of X-ray films and storage foils. Storage foils contain, in a transparent plastic matrix, phosphorus particles with colour centres that can be brought into a stable state of excitation by X-ray light. By scanning with a reading laser beam, the excited states can be brought into a more highly excited state which quickly relaxes, accompanied by emission of fluorescent light. As a result of detection of the latter, the latent image of a storage foil can consequently be read out.

By way of alternative embodiment, in FIG. 4 a detection unit 14 corresponding to FIG. 3 is represented, into which CCD detectors or CMOS detectors 76 have been introduced instead of the detector foils 74. The detectors 76 being used exhibit a planar, radiosensitive surface 77 pointing towards the X-ray source 12 under operating conditions and each only partly absorb the X-radiation impinging on them.

The detectors 76 may be standard CCD detectors or CMOS detectors reacting to visible light, which are provided with a layer of luminescent material (partly) absorbing X-ray beams or are arranged behind an appropriate fluorescent screen.

By virtue of the configuration of the housing 62, the detector foils 74 or detectors 76 are arranged in the detection unit 14 one behind the other in echelon in such a way that their planar surfaces 75 and 77, respectively, pointing towards the X-ray source under operating conditions are oriented parallel to one another.

With the use of CCD detectors or CMOS detectors 76, these are connected to the control/computing unit 56 via a multiwire data-line cable 78 which is represented in FIGS. 1 and 2 by a dotted line. When the control/computing unit 56 receives the data, either it can evaluate the data directly and generate therefrom a two-dimensional image for each detector 76, or for the purpose of evaluation the data can be forwarded from the control/computing unit 56 to an external computer which is not represented here.

The data-line cable 78 may also be replaced by a wireless data-transmission link, for example an infrared data-transmission link, a Bluetooth data-transmission link or such like.

The side wall of the housing 62 that, as intended, faces towards the X-ray source 12 and is denoted in FIGS. 3 and 4 by reference symbol 80 consists of a material that absorbs X-radiation only to a slight extent, such as, for example, a thin blackened film consisting of polyethylene terephthalate or a thin metal film consisting of a metal with a low atomic number.

If use is made of CCD detectors or CMOS detectors 76 that have their own light-proof sheaths, the side wall 80 of the housing 62 may also be dispensed with completely. Generally only those housing parts are then required which are required for parallel-spaced retention of the detectors 76.

The same holds for detector foils (X-ray films or storage foils) in a protective sheath that is opaque to visible light.

Deviating from the number of detector foils 74 or detectors 76 shown respectively in FIGS. 3 and 4, the housing 62 may also be configured for the accommodation of more or less than 5 detector foils 74 or detectors 76. In particular, 3 detector foils 74 or detectors 76 enter into consideration, but use may also be made of 7, 9 and more detectors 74 or 76, as well as an intermediate number.

Detector foils and detectors may also be combined in a detection unit 14 in order to profit jointly from the special advantages thereof with respect to resolution and sensitivity as well as speed of the provision of a visual perceptible image.

In FIGS. 5 and 6 a possible mode of operation of the X-ray apparatus 10 is shown, using a detection unit 14 with three detectors 74A, B, C or 76A, B, C, on the one hand (FIG. 5), and with five detectors 74A, B, C, D, E or 76A, B, C, D, E on the other hand (FIG. 6).

In each case two variants for the movement of the detection unit 14 are represented: in solid lines a motion during which the detector foils 74 or the detectors 76 are held parallel to the displacement path 88; and in broken lines a motion during which the detector foils 74 or the detectors 76 are jointly rotated in such a way that they are perpendicular to the X-ray beam.

By way of object to be transilluminated, in exemplary manner a circular-arc-shaped portion of a dental arch 82 of a patient is shown which in also represented in FIG. 1.

In FIG. 5 the source of X-radiation 12 is shown in three different positions RA, RB and RC. These three positions are traversed by the source of X-radiation 12 during an exposure, in that principal arm 48′ of the articulated bar linkage 16 is moved by means of the electric motors 26′ and 36′ in such a manner that the source of X-radiation 12 moves along a rectilinear radiation-source displacement path 86.

During the displacing of the source of X-radiation 12 the latter is rotated by means of the electric motor 44′ in such a manner that a radiation exit port 84 of the source of X-radiation 12 always points in the direction of the detector unit 14.

The detection unit 14 is, in turn, displaced along a rectilinear detection-unit displacement path 88 during an exposure in opposite manner relative to the movement of the source of X-radiation 12 by means of principal arm 48 via an appropriate drive of the electric motors 26 and 36. This means that the detection unit 14 assumes positions SA, SB and SC when the source of X-radiation 12 is in positions RA, RB and RC, respectively, as shown in FIGS. 5 and 6.

By means of the electric motor 44 the detection unit 14 is rotated about the z-axis during its movement along the displacement path 88 in such a manner that the radiosensitive surface 75 or 77 of the detector foils 74 or detectors 76, respectively, extending in each case in an xz-plane, is always oriented parallel to the displacement path 88. This can be readily discerned in FIGS. 5 and 6.

In the case of positions of the source of X-radiation 12 and of the detection unit 14 other than those shown in FIGS. 5 and 6, the circumstances are to be understood correspondingly.

If the entire dental arch is to be captured in several correspondingly curved focal surfaces, then it is expedient to arrange upstream of the detection unit 14 a vertical (extending in the z-direction) slit 100 that is effective for X-ray beams and that is always struck perpendicularly by the X-radiation, as represented in FIG. 8, and to place the centre of rotation outside a middle focal surface 90B.

During the movement of the source of X-radiation 12 around the dental arch 82 three detector foils 74A, 74B, 74C 3 arranged downstream are then both rotated by the angle of rotation of the source of X-radiation 12 and rectilinearly displaced with respect to the X-ray slit 100, as shown in FIG. 8 for three exposure positions.

Here, by way of example, an approximately circular-arc-shaped portion of a dental arch 82 is assumed, and the source of X-radiation 12 is moved at a fixed spacing from a cylindrical focal surface within the dental arch, so that it is always perpendicular to this focal surface.

Three detector foils 74A, 74B and 74C (or three detectors 76) are similarly held with the X-ray slit 100 at a fixed spacing from the associated focal surface 90A, 90B, 90C and are swivelled by the same angle. The centre of rotation 92 is located in this case in the centre or centre of curvature of the focal surfaces 90A, 90B and 90C, which are sharply imaged on the detector foils 74A, to 74B and 74C.

To this end, storage foil 74 is displaced in the course of a rotation by an angle w in such a manner that, for example, point P1 changes to point P1′, point P2 changes to point P2′.

If the other storage foils 74A and 74C are displaced by the same distance, then, by virtue of this form of movement of the detector-foil stack, of the slit 100 and of the source of X-radiation 12, images are recorded on the detector foils 74A, 74B, 74C, one behind the other in echelon, which correspond to the sectional images in the focal surfaces 90A, 90B, 90C.

By a change of the spacing of the detector foils 74 in the foil stack, the spacings of the circular focal surfaces 90A, 90B, 90C can be influenced.

Similarly, it is possible to choose the translational velocities of the detector foils 74A, 74B, 74C to be different. The spacing of the focal surfaces is also influenced by this means. If, for example, detector foil 74C is displaced more quickly in the direction of the detection displacement path 88, the associated focal surface 90C migrates outwards.

The entire sequences of motions of the source of X-radiation 12 and of the detection unit 14 are matched to one another in such a way during an exposure that, as mentioned in the introduction, narrow vertical exposure regions of single images on the detectors 74 or 76 are imaged in combined manner so as to yield an overall image.

By virtue of the fact that in the detection unit 14 several detector foils 74 or detectors 76 are provided which only partly absorb the X-radiation impinging on them, on the respective detector foils 74 or detectors 76 in each case differing sectional images of the dental arch 82 are generated.

In the detection unit 14 in FIG. 5 three detector foils 74A, 74B and 74C are provided. The sectional planes imaged thereon correspond to the focal planes 90A, 90B and 90C represented in each instance by a solid line.

As can be discerned in FIG. 5, the focal planes 90A, 90B and 90C are located one behind the other in echelon corresponding to the arrangement of the detector foils 74A, 74B, 74C within the detection unit 14.

The spacing d between the focal planes 90A and 90B and, respectively, 90B and 90C is dependent on the arrangement both of the source of X-radiation 12 and of the detection unit 14 and of the detector foils 74 accommodated therein relative to one another.

Assuming a position of the source of X-radiation 12 and of the detection unit 14 directly opposite, as is the case with position RB of the source of X-radiation 12 and position SB of the detection unit 14, the spacing d between two adjacent focal planes 90 can be ascertained as follows:

If a is the spacing between the central detector foil 74B and the centre of rotation 92, b is the spacing between the source of X-radiation 12 and the centre of rotation 92, and c is the spacing between two adjacent detector foils 74A, 74B and 74B, 74C, then the spacing d between two adjacent focal planes 90A, 90B and 90B, 90C is calculated in accordance with

d=b×c/(a+b).

The respective spacings are denoted in FIGS. 5 and 6 by the corresponding letters, in which connection the circumstances shown in the Figures do not correspond quantitatively to the actual circumstances.

With the use of three detector foils 74A to 74C three focal planes 90A to 90C accordingly result which are present with a spacing d from one another.

In this case the position of the source of X-radiation 12, which is drawn upon for the purpose of calculating the position and the spacing d of the focal plane 90 and for the purpose of determining the spacing b, is understood to be the averaged place of origin of the X-radiation, for example the averaged location of an X-ray cathode.

In the Figures the source of X-radiation 12 is shown schematically as a circular cylinder, it being assumed that the averaged place of origin of the X-radiation lies in the axial centre of the circular cylinder.

In FIG. 6 the arrangement with a detection unit 14 is shown which uses five detector foils 74A to 74E. In comparison with the exemplary embodiment according to FIG. 5, the detection unit 14 exhibits an additional storage foil 7492 arranged nearer in the direction of the source of X-radiation 12 and an additional detector foil 74E provided on the opposite side of the detection unit 14.

Accordingly, on the detector foils 74A to 74E there is sharply imaged in each instance a focal plane 90A, 90B, 90C, 9092 and 90E, of which in each instance two adjacent focal planes 90 are present with a spacing d from one another which is calculated in accordance with the formula stated above.

The calculation of the spacing d which was elucidated on the basis of the example constituted by the detector foils 74 is undertaken analogously in the case of CCD detectors or CMOS detectors 76. For the purpose of determining the spacings a and b, in this case the position of the radiosensitive surface is 77 is taken as reference quantity.

By virtue of the arrangement of the source of X-radiation 12 and of the detection unit 14 relative to one another, and also by virtue of the use of several detector foils 74 or detectors 76 or combinations thereof arranged one behind the other, with only one exposure in several focal planes 90 situated one behind the other it is possible to image the X-ray density of the object sharply onto the respective detector foils 74 or detectors 76. The X-ray dose necessary for this—for example in the case of a dental, intraoral radiograph illustrated here on the basis of the example constituted by the dental arch 82—is of the same order of magnitude as in the case of an intraoral standard single exposure.

The X-radiation transmitted by a detector foil 74 or by a detector 76 reaches detector foils 74 or detectors 76 situated behind it, so that with the same radiation burden sectional images corresponding to the number of detector foils 74 or detectors 76 being used can be generated.

In FIG. 7 a diagram is represented which shows the decrease in intensity of the X-ray light in a stack of ten intraoral standard detector foils in the case of a tube voltage of 70 kV, corresponding to about 35 keV of mean X-ray energy.

As can be discerned qualitatively in FIG. 7, the X-radiation is present with relatively high intensity also after penetrating several detector foils, this being sufficient to generate an image on, in each instance, a subsequent detector foil.

Planes situated outside the focal planes 90 are represented in blurred manner on the detectors 74 or 76.

With the use of detector foils 74, after the digital read-out the captured sectional images can be edited with a conventional image editing which removes the mean X-ray density from those image planes which lies outside the focal plane 90 assigned to the corresponding detector foil 74.

With the use of CCD detectors 76 or CMOS detectors 76, the image editing is effected automatically by the control/computing unit 56 or, as mentioned, by an external computer.

The aforementioned luminous unit 94 is fitted to the double joint 22 at the level of the source of X-radiation 12 and the detection unit 14. Corresponding to the number of detectors 74 and 76 being used, it projects light in linear manner, in each instance in an xz-plane, onto the object 82, for example by means of, in each instance, an array of light-emitting diodes 96.

The spacing between two xz-planes that are to be assigned in each instance to a beam of light, and the position thereof, correspond to the spacing d between the focal planes 90 and, respectively, the position of the focal planes 90.

In this way, reference lines can be projected onto the outer contour of the object 82 in order to orient the object 82 prior to the X-ray exposure in accordance with the position of the focal planes 90.

The individual arrays of light-emitting diodes 96 can be displaced on the y-axis by means of electric motors 98 and, when use is being made of differing detection units 14 in the case of which the spacing c between the detectors 74 or 76 turns out to be different, can be positioned relative to one another in accordance with the calculated spacing d.

The basic principle, elucidated above, for generating several sectional images is applicable not only in the case of rectilinear paths 86 and 88 of the source of X-radiation 12 and of the detector unit 14, respectively.

Also a use in the case of so-called panoramic radiographs, for example, in the case of which the source of X-radiation and the detection unit are moved on arcuate paths, enters into consideration.

The following further modifications of the exemplary embodiments described above are possible:

The detection unit 14 includes at least two of the detector-types named below: silver-halide films, storage foils, image-converter-based detectors.

The detection unit 14 includes at least two detector foils 74 and/or detectors 76 which differ in their response to the X-ray beams emitted by the source of X-radiation 12.

The effective X-ray cross-section of the detectors preferentially increases in the beam direction.

If the increase in the effective cross-section of the detectors is chosen so that the amount of the X-ray light absorbed in the detectors is substantially the same, the images generated by the detectors have substantially the same tone density and the same contrast.

If for at least one of the detectors of the detection unit a servo drive is provided which additionally moves the detector, in the course of moving along the detection path, parallel to the detector plane or antiparallel to the latter, then the position of the assigned focal plane can be influenced by this means.

In this connection the additional movement is preferentially proportional to the travel of the detection unit 14.

Preferentially the additional movement is also proportional to the spacing of the detector being considered from the centre of the detection unit, viewed in the beam direction.

1. An X-ray apparatus comprising:
a source of X-radiation for transirradiating an object, said source being capable of being moved along a source path by means of a first drive means; and
a detection unit on which X-radiation impinges after penetrating the object and which is capable of being displaced along a detector path by means of a second drive means,
wherein the detection unit includes at least two detectors which react to X-ray light and are arranged one behind the other in parallel-spaced manner; and
wherein the detectors, where appropriate with the exception of a rearmost, each absorb only a part of the X-radiation impinging on them.

2. The X-ray apparatus according to claim 1, wherein principal surfaces of the detectors standing perpendicular to the beam direction are substantially planar.

3. The X-ray apparatus according to claim 1, wherein the detectors are detector foils or storage foils.

4. The X-ray apparatus according to claim 1, wherein the detectors are CCD detectors or CMOS detectors.

5. The X-ray apparatus according to claim 1, wherein between three and eleven detectors are provided.

6. The X-ray apparatus according to claim 5, wherein three detectors are provided.

7. The X-ray apparatus according to claim 5, wherein five detectors are provided.

8. The X-ray apparatus according to claim 5, wherein seven detectors are provided.

9. The X-ray apparatus according to claim 1, further comprising a luminous unit which projects a line pattern corresponding to the position and number of focal planes onto the outer contour of the object.

10. The X-ray apparatus according to claim 9, wherein the luminous unit includes arrays of light-emitting diodes corresponding to the number of focal planes.

11. A detection unit for the X-ray apparatus according claim 1, with at least one detector resolving at least two-dimensionally and sensitive to X-ray light, wherein
a) at least two detectors are provided which are arranged in parallel-spaced manner;
b) the detectors, where appropriate with the exception of a rearmost, only partly absorb X-radiation.

12. The detection unit according to claim 11, comprising a housing which, with the exception of an entrance window, is manufactured from opaque material.

13. The detection unit according to claim 12, wherein in a side wall of the housing there are provided openings through which the detectors can be inserted into the housing.

14. The detection unit according to claim 12, wherein the detectors are seated in guide grooves within the housing.

15. The detection unit according to claim 12, wherein a side wall of the housing includes a plastic film, in particular a blackened film consisting of polyethylene terephthalate.

16. The detection unit according to claim 12, wherein a side wall of the housing is a foil consisting of a metal with a low atomic number, which absorbs X-radiation only to a slight extent.

17. The detection unit according to claim 11, wherein detector foils or storage foils, are provided by way of detectors.

18. The detection unit according to claim 11, wherein CCD detectors or CMOS detectors are provided by way of detectors.

19. The detection unit according to claim 11, wherein for the detection unit a servo drive is provided which keeps the detection unit oriented parallel to the detection path in the course of moving along the detection path.

20. The detection unit according to claim 11, wherein for the detection unit a servo drive is provided which keeps the detection unit oriented perpendicular to the beam direction in the course of moving along the detection path.

21. The detection unit according to claim 11, wherein the detection unit includes at least two of the detector-types named below: silver-halide films, storage foils, image-converter-based detectors.

22. The detection unit according to claim 11, wherein the detection unit includes at least two detectors which differ in their response to the X-radiation emitted by the source of X-radiation.

23. The detection unit according to claim 22, wherein the effective X-ray cross-section of the detectors increases in the beam direction.

24. The detection unit according to claim 23, wherein the increase in the effective cross-section is chosen so that the amount of X-ray light absorbed in the detectors is substantially the same.

25. The detection unit according to claim 11, wherein for at least one of the detectors of the detection unit a servo drive is provided which additionally moves the detector parallel to the detector plane or antiparallel to the latter in the course of moving along the detection path.

26. The detection unit according to claim 25, wherein the additional movement is proportional to the travel of the detection unit.

27. The detection unit according to claim 25, wherein the additional movement is proportional to the spacing of the detector being considered from the centre of the detection unit, viewed in the beam direction.
